(19) United States
(12) Patent Application Publication
(10) Pub. No.: US 2019/0228708 A1
(43) Pub. Date: Jul. 25, 2019

(54) PIXEL CIRCUIT, PIXEL DRIVING METHOD AND DISPLAY DEVICE

(71) Applicant: BOE TECHNOLOGY GROUP CO., LTD., Beijing (CN)

(72) Inventors: Shengji YANG, Beijing (CN); Xue DONG, Beijing (CN); Jing LV, Beijing (CN); Xiaochuan CHEN, Beijing (CN); Minghua XUAN, Beijing (CN)

(21) Appl. No.: 16/329,091

(22) PCT Filed: May 31, 2018
(86) PCT No.: PCT/CN2018/089120

§ 371 Date: Feb. 27, 2019

(30) Foreign Application Priority Data
Jun. 14, 2017 (CN) 201710447592.5

(51) Int. Cl. G09G 3/3233

(52) U.S. Cl. CPC G09G 3/3233; G09G 2300/0819; G09G 2320/0233

(57) ABSTRACT

The present disclosure provides a pixel circuit, a pixel driving method, and a display device. The pixel circuit includes a driving transistor, a threshold compensation sub-circuit, and a light emission control sub-circuit. The threshold compensation sub-circuit is configured to write a reset voltage to the control terminal of the driving transistor in a reset phase under the control of the first, second and third control signal terminal, and write a control voltage to the control terminal of the driving transistor in a data writing phase. The driving transistor is configured to generate a driving current according to the control voltage in a light emitting phase. The light emission control sub-circuit is configured to output the driving current to the light emitting device in the light emission phase under the control of the light emission control signal terminal to drive the light emitting device to emit light.

### RELATED APPLICATION

The present application claims the benefit of Chinese Patent Application No. 201710447592.5, filed on Jun. 14, 2017, the entire disclosure of which is incorporated herein by reference.

### FIELD

The present disclosure relates to the field of display technologies, and particularly to a pixel circuit, a pixel driving method and a display device.

### BACKGROUND

Active matrix organic light emitting diode (AMOLED) display devices are becoming more and more widely used. A pixel display device of an AMOLED display device comprises an organic light emitting diode (OLED). A driving thin film transistor in each pixel generates a driving current in a saturated state, and the driving current drives a corresponding OLED to emit light.

### SUMMARY

An aspect of the present disclosure provides a pixel circuit comprising a driving transistor, a threshold compensation sub-circuit, and a light emission control sub-circuit. A control terminal, a first terminal and a second terminal of the driving transistor are connected to the threshold compensation sub-circuit; the threshold compensation sub-circuit is connected to a data line, a first power supply terminal, a first control signal terminal, a second control signal terminal, a third control signal terminal, and the light emission control sub-circuit; the light emission control sub-circuit is connected to a first end of a light emitting device and a light emission control signal terminal; a second end of the light emitting device is connected to a second power supply terminal. The threshold compensation sub-circuit is configured to write a reset voltage to the control terminal of the driving transistor in a reset phase under the control of the first control signal terminal, the second control signal terminal and the third control signal terminal, the reset voltage being equal to a sum of a first voltage provided by the first power supply terminal and a threshold voltage of the driving transistor, and write a control voltage to the control terminal of the driving transistor in a data writing phase, the control voltage being related to the reset voltage and a data voltage provided by the data line. The driving transistor is configured to generate a driving current according to the control voltage in a light emitting phase. The light emission control sub-circuit is configured to output the driving current to the light emitting device in the light emission phase under the control of the light emission control signal terminal to drive the light emitting device to emit light.

According to some embodiments of the present disclosure, the control voltage is equal to a sum of a difference between a second data voltage provided by the data line in the data writing phase and a first data voltage provided by the data line in the reset phase and the reset voltage.

According to some embodiments of the present disclosure, the threshold compensation sub-circuit comprises a first transistor, a second transistor, a third transistor, and a capacitor. A control terminal of the first transistor is connected to the first control signal terminal, a first terminal of the first transistor is connected to the first power supply terminal, and a second terminal of the first transistor is connected to the first terminal of the driving transistor; a control terminal of the second transistor is connected to the second control signal terminal, a first terminal of the second transistor is connected to the data line, and a second terminal of the second transistor is connected to a first end of the capacitor; a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor.

According to some embodiments of the present disclosure, the second control signal terminal and the third control signal terminal are a same control signal terminal.

According to some embodiments of the present disclosure, the light emission control sub-circuit comprises a fourth transistor. A control terminal of the fourth transistor is connected to the light emission control signal line, a first terminal of the fourth transistor is connected to the second terminal of the driving transistor, and a second terminal of the fourth transistor is connected to the first end of the light emitting device.

According to some embodiments of the present disclosure, the first transistor, the second transistor, the third transistor, the fourth transistor, and the driving transistor are P-type transistors.

Another aspect of the present disclosure provides a display device comprising any of the pixel circuits described above.

A further aspect of the present disclosure provides a pixel driving method, using any of the pixel circuits described above. The pixel driving method comprises:

in a reset phase, writing, by the threshold compensation sub-circuit, a reset voltage to the control terminal of the driving transistor, the reset voltage being equal to a sum of a first voltage provided by the first power supply terminal and a threshold voltage of the driving transistor;

in a data writing phase, writing, by the threshold compensation sub-circuit, a control voltage to the control terminal of the driving transistor, the control voltage being related to the reset voltage and a data voltage provided by the data line;

in a light emitting phase, generating, by the driving transistor, a driving current according to the control voltage, and outputting, by the light emission control sub-circuit, the driving current to the light emitting device to drive the light emitting device to emit light.

According to some embodiments of the present disclosure, said in a reset phase, writing, by the threshold compensation sub-circuit, a reset voltage to the control terminal of the driving transistor includes: turning on the first transistor under the control of the first control signal terminal, turning on the second transistor under the control of the second control signal terminal, turning on the third transistor under the control of the third control signal terminal, and turning off the fourth transistor under the control of the light emission control signal terminal.

According to some embodiments of the present disclosure, said in a data writing phase, writing, by the threshold compensation sub-circuit, a control voltage to the control terminal of the driving transistor includes: turning off the first transistor under the control of the first control signal terminal, turning on the second transistor under the control of the second control signal terminal, turning on the third transistor under the control of the third control signal terminal, and turning off the fourth transistor under the control of the light emission control signal terminal.

According to some embodiments of the present disclosure, said in a light emitting phase, generating, by the driving transistor, a driving current according to the control voltage, and outputting, by the light emission control sub-circuit, the driving current to the light emitting device to drive the light emitting device to emit light include: turning on the first transistor under the control of the first control signal terminal, turning off the second transistor under the control of the second control signal terminal, turning off the third transistor under the control of the third control signal terminal, and turning on the fourth transistor under the control of the light emission control signal terminal.

### BRIEF DESCRIPTION OF THE DRAWINGS

FIG. 1 is a schematic structural view of a typical pixel circuit;

FIG. 2 is a schematic structural view of a pixel circuit provided by an embodiment of the present disclosure;

FIG. 3 is a flowchart of a pixel driving method provided by an embodiment of the present disclosure;

FIG. 4 is a schematic view illustrating a specific circuit structure of a pixel circuit provided by an embodiment of the present disclosure;

FIG. 5 is a timing diagram illustrating the operation of the pixel circuit shown in FIG. 4;

FIG. 6 is an equivalent circuit diagram of the pixel circuit shown in FIG. 4 in a reset phase;

FIG. 7 is an equivalent circuit diagram of the pixel circuit shown in FIG. 4 in a data writing phase;

FIG. 8 is an equivalent circuit diagram of the pixel circuit shown in FIG. 4 in a light emitting phase; and

FIG. 9 is a flow chart of another pixel driving method provided by an embodiment of the present disclosure.

### DETAILED DESCRIPTION

In order to enable those skilled in the art to better understand the technical solutions of the present disclosure, the pixel circuit, the pixel driving method, and the display device provided by the present disclosure are described in detail below with reference to the accompanying drawings.

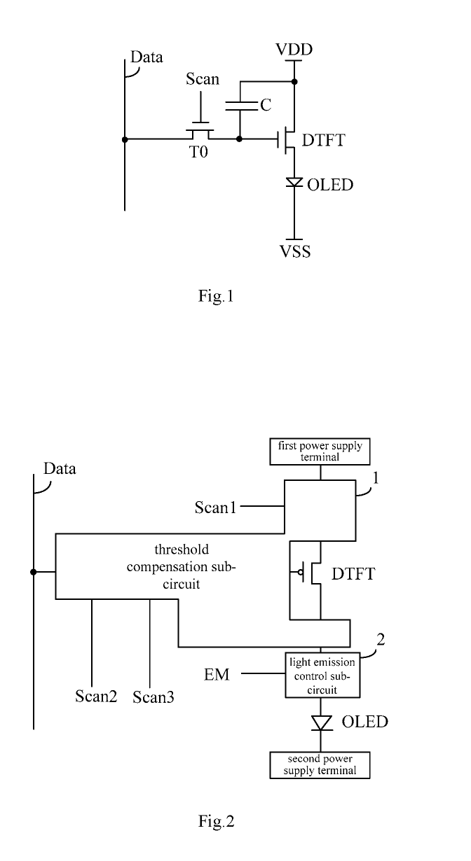

FIG. 1 is a schematic structural view of a typical pixel circuit. As shown in FIG. 1, the pixel circuit is a 2T1C circuit, that is, comprising two transistors (a switching transistor T0 and a driving transistor DTFT) and one storage capacitor C. A control terminal of the driving transistor DTFT is connected to a first terminal of the switching transistor T0 and one end of the storage capacitor C, a first terminal of the driving transistor DTFT is connected to a first level signal terminal VDD and the other end of the storage capacitor C, and a second terminal of the driving transistor DTFT is connected to one end of a light emitting device OLED. A control terminal of the switching transistor T0 is connected to a scan signal terminal Scan, and the first terminal of the switching transistor T0 is connected to a data line Data. The other end of the light emitting device OLED is connected to a second level signal terminal VSS. When the driving transistor DTFT drives the light emitting device OLED to emit light, the driving current is controlled by the first level signal terminal VDD, the data line Data, and the driving transistor DTFT together.

In actual use, luminance of an OLED is quite sensitive to changes in its driving current. Unfortunately, since driving transistors DTFT in respective pixel circuits cannot be made identical during the manufacturing process, and threshold voltages Vth of the driving transistors DTFT in respective pixel circuits are not uniform due to process procedures, device aging, temperature change during operation, and other reasons, the current flowing through the OLED of each pixel is changed, so that the display brightness is uneven, which further affects the display effect of an entire image. FIG. 2 is a schematic structural view of a pixel circuit provided by an embodiment of the present disclosure. As shown in FIG. 2, the pixel circuit comprises a driving transistor DTFT, a threshold compensation sub-circuit 1 and a light emission control sub-circuit 2.

A control terminal, a first terminal and a second terminal of the driving transistor DTFT are connected to the threshold compensation sub-circuit 1. The threshold compensation sub-circuit 1 is connected to a data line Data, a first power supply terminal, a first control signal terminal Scan1, a second control signal terminal Scan2, a third control signal terminal Scan3, and a light emission control sub-circuit 2. The light emission control sub-circuit 2 is connected to a first end of a light emitting device OLED and a light emission control signal terminal EM. A second end of the light emitting device OLED is connected to a second power supply terminal.

The threshold compensation sub-circuit 1 is configured to write a reset voltage to the control terminal of the driving transistor DTFT in a reset phase under the control of the first control signal terminal Scan1, the second control signal terminal Scan2, and the third control signal terminal Scan3, the reset voltage being equal to a sum of a first voltage provided by the first power supply terminal and a threshold voltage of the driving transistor DTFT, and write a control voltage to the control terminal of the driving transistor DTFT in a data writing phase, the control voltage being related to the reset voltage and a data voltage provided by the data line Data.

The driving transistor DTFT is configured to generate a driving current according to the control voltage in a light emitting phase.

The light emission control sub-circuit 2 is configured to output the driving current to the light emitting device OLED in the light emitting phase under the control of the light emission control signal terminal EM to drive the light emitting device OLED to emit light.

In this embodiment, the first power supply terminal is configured to provide a first voltage Vdd, and the second power supply terminal is configured to provide a second voltage Vss.

It is to be noted that the light emitting device in this embodiment may be any current-driven light emitting device including a light emitting diode (LED) or an organic light emitting diode (OLED). In the present embodiment, an OLED is taken as an example for description.

In the above-described pixel circuit, a reset voltage equal to a sum of the first voltage and the threshold voltage of the driving transistor DTFT is written to the control terminal of the driving transistor DTFT by the threshold compensation sub-circuit 1 in the reset phase, and a control voltage related to the reset voltage and the data voltage provided by the data line Data is written to the control terminal of the driving transistor DTFT by the threshold compensation sub-circuit 1 in the data writing phase, so that the driving current generated by the driving transistor DTFT in the light emitting phase is independent of the threshold voltage of the driving transistor DTFT, which thus eliminates the influence of the drift of the threshold voltage of the driving transistor DTFT on the driving current of the light emitting device OLED, thereby effectively improving the luminance uniformity of pixels in the display device.

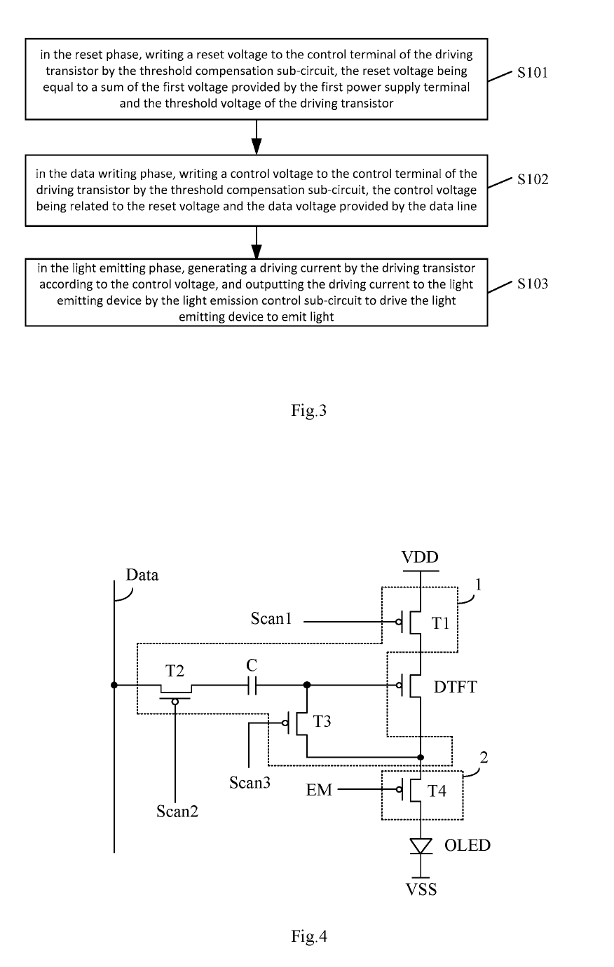

FIG. 3 is a flow chart of a pixel driving method provided by an embodiment of the present disclosure. The pixel driving method may employ the pixel circuit as shown in FIG. 2. The specific structure of the pixel circuit can be referred to the foregoing contents, and details are not described herein again. As shown in FIG. 3, at step S101, in the reset phase, a reset voltage is written to the control terminal of the driving transistor by the threshold compensation sub-circuit, and the reset voltage is equal to a sum of the first voltage provided by the first power supply terminal and the threshold voltage of the driving transistor.

At step S102, in the data writing phase, a control voltage is written to the control terminal of the driving transistor by the threshold compensation sub-circuit, and the control voltage is related to the reset voltage and the data voltage provided by the data line.

In this step S102, since the reset voltage is equal to a sum of the first voltage and the threshold voltage of the driving transistor DTFT, the control voltage written to the control terminal of the driving transistor DTFT also necessarily includes a component of the sum of the first voltage and the threshold voltage of the driving transistor DTFT, which component can compensate the threshold voltage of the driving transistor DTFT in the subsequent light emitting phase.

Further, a component of the data voltage provided by the data line Data in the control voltage may control the magnitude of the driving current outputted by the driving transistor DTFT.

In an exemplary embodiment, the control voltage is equal to a sum of the difference between a second data voltage provided by the data line Data in the data writing phase and a first data voltage provided in the reset phase and the reset voltage.

At step S103, in the light emitting phase, a driving current is generated by the driving transistor according to the control voltage, and the driving current is outputted to the light emitting device by the light emission control sub-circuit to drive the light emitting device to emit light.

In the above-described pixel driving method, a reset voltage equal to a sum of the first voltage and the threshold voltage of the driving transistor is written to the control terminal of the driving transistor by the threshold compensation sub-circuit in the reset phase, and a control voltage related to the reset voltage and the data voltage provided by the data line is written to the control terminal of the driving transistor by the threshold compensation sub-circuit in the data writing phase, so that the driving current generated by the driving transistor in the light emitting phase is independent of the threshold voltage of the driving transistor, which thus eliminates the influence of the drift of the threshold voltage of the driving transistor on the driving current of the light emitting device, thereby effectively improving the luminance uniformity of pixels in the display device.

FIG. 4 is a schematic view illustrating a specific circuit structure of a pixel circuit provided by an embodiment of the present disclosure. As shown in FIG. 4, in an exemplary embodiment, the threshold compensation sub-circuit 1 comprises a first transistor T1, a second transistor T2, a third transistor T3, and a capacitor C.

A control terminal of the first transistor T1 is connected to the first control signal terminal Scan1, a first terminal of the first transistor T1 is connected to the first power supply terminal VDD, and a second terminal of the first transistor T1 is connected to the first terminal of the driving transistor DTFT.

A control terminal of the second transistor T2 is connected to the second control signal terminal Scan2, a first terminal of the second transistor T2 is connected to the data line Data, and a second terminal of the second transistor T2 is connected to a first end of the capacitor C.

A control terminal of the third transistor T3 is connected to the third control signal terminal Scan3, a first terminal of the third transistor T3 is connected to the second terminal of the driving transistor DTFT, and a second terminal of the third transistor T3 is connected to a second end of the capacitor C and the control terminal of the driving transistor DTFT.

In an exemplary embodiment, optionally, the second control signal terminal Scan2 and the third control signal terminal Scan3 may be the same control signal terminal. In this case, the control terminal of the second transistor T2 and the control terminal of the third transistor T3 are controlled by a control signal provided by the same control signal terminal, so that the number of signal wirings arranged in the pixel circuit can be effectively reduced while achieving pixel driving, which helps to increase the pixel aperture ratio.

In an exemplary embodiment, as shown in FIG. 4, the light emission control sub-circuit 2 comprises a fourth transistor T4. A control terminal of the fourth transistor T4 is connected to the light emission control signal terminal EM, a first terminal of the fourth transistor T4 is connected to the second terminal of the driving transistor DTFT, and a second terminal of the fourth transistor T4 is connected to the first end of the light emitting device OLED. The second terminal of the light emitting device OLED is connected to the second power supply terminal VSS.

It is to be noted that the driving transistor DTFT, the first transistor T1, the second transistor T2, the third transistor T3, and the fourth transistor T4 in this embodiment are independently selected from one of a polysilicon thin film transistor, an amorphous silicon thin film transistor, an oxide thin film transistor and an organic thin film transistor, and the like, respectively. The first transistor T1, the second transistor T2, the third transistor T3, and the fourth transistor T4 are used as switching transistors, and the driving transistor DTFT is used as a driving transistor.

As used herein, the “control terminal” mentioned in this embodiment may refer to a gate of a transistor, the “first terminal” may refer to one of a source and a drain of the transistor, and the “second terminal” may refer to the other of the source and the drain of the transistor.

It is to be noted that although FIG. 4 describes the configuration of the pixel circuit according to an embodiment of the present disclosure based on an example in which each transistor is a P-type transistor, each transistor may be an N-type transistor or a P-type transistor independently. When the transistors in the pixel circuit shown in FIG. 4 are of the same type (all of which are, for example, P-type transistors or N-type transistors), the same manufacturing process may be employed to prepare all the transistors simultaneously, so that the production cycle of the pixel circuit can be shortened.

As used herein, the “first end” and the “second end” of a light emitting device OLED may refer to an anode and a cathode of the light emitting device OLED, respectively.

To enable those skilled in the art to better understand the technical solutions of the present disclosure, the operating process of the pixel circuit provided by this embodiment will be described in detail below with reference to the accompanying drawings. The description below is based on an example in which each transistor in the pixel circuit is a P-type transistor, and the second control signal terminal Scan2 and the third control signal terminal Scan3 are the same control signal terminal. However, the concept of the present disclosure is not limited thereto.

It is assumed that the first power supply terminal VDD provides a first voltage Vdd, the second power supply terminal VSS provides a second voltage Vss, and the threshold voltage of the driving transistor DTFT is Vth. For P-type transistors, Vth takes a negative value.

FIG. 5 is a timing diagram showing the operation of the pixel circuit shown in FIG. 4. As shown in FIG. 5, the operating process of the pixel circuit includes three phases: a reset phase t1, a data writing phase t2, and a light emitting phase t3.

In the reset phase t1, the first control signal terminal Scan1 provides a low level signal, the second control signal terminal Scan2 and the third control signal terminal Scan3 provide a low level signal, and the light emission control signal terminal EM provides a high level signal. At that time, the first transistor T1, the second transistor T2, and the third transistor T3 are all turned on, and the fourth transistor T4 is turned off.

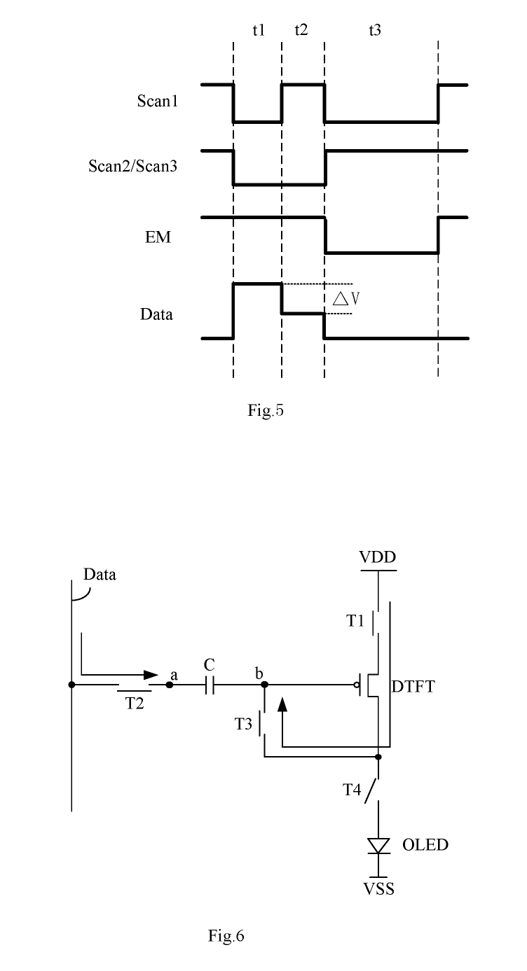

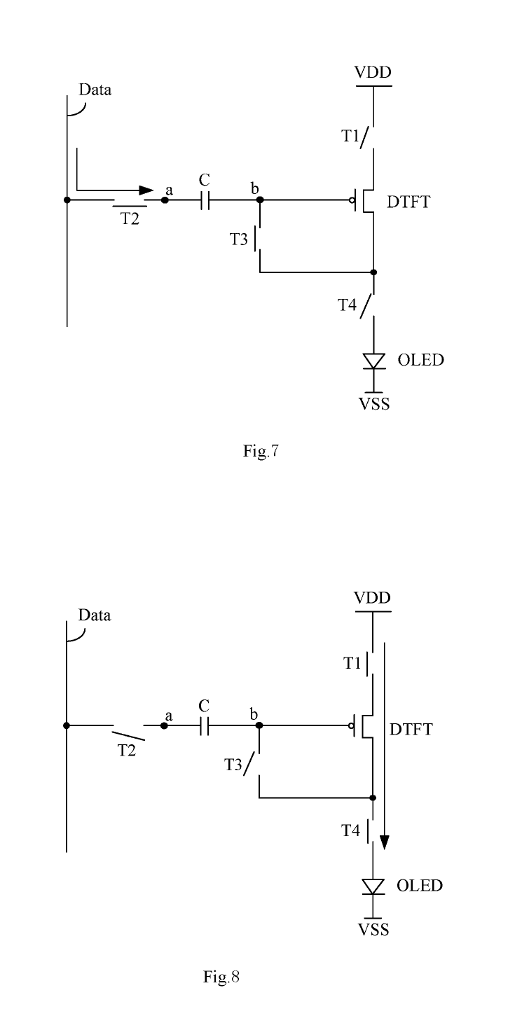

FIG. 6 is an equivalent circuit diagram of the pixel circuit shown in FIG. 4 in the reset phase. As shown in FIG. 6, since the second transistor T2 is turned on, the first data voltage provided by the data line Data is written to the first end of the capacitor C through the second transistor T2. It is assumed that the first data voltage is Vdata′, that is, the voltage of a node a is Vdata′ at that time.

Since the first transistor T1 and the third transistor T3 are turned on, the first power supply terminal VDD charges the control terminal of the driving transistor DTFT through the first transistor T1, the driving transistor DTFT, and the third transistor T3 sequentially until the voltage of the control terminal of the driving transistor DTFT rises to Vdd+Vth. The driving transistor DTFT is turned off, and charging is finished. At that time, the voltage of a node b is the reset voltage, the value of which is Vdd+Vth.

It is to be noted that, since the fourth transistor T4 is in an off state at that time, the driving current cannot flow through the fourth transistor T4, and the light emitting device OLED does not emit light.

In the data writing phase t2, the first control signal terminal Scan1 provides a high level signal, the second control signal terminal Scan2 and the third control signal terminal Scan3 provide a low level signal, and the light emission control signal terminal EM provides a high level signal. At that time, the second transistor T2 and the third transistor T3 are both turned on, and the first transistor T1 and the fourth transistor T4 are both turned off.

FIG. 7 is an equivalent circuit diagram of the pixel circuit shown in FIG. 4 in the data writing phase. As shown in FIG. 7, the data line Data provides a second data voltage which may be smaller than the first data voltage. Since the second transistor T2 is turned on, the second data voltage provided by the data line Data is written to the first end of the capacitor C through the second transistor T2. It is assumed that the second data voltage is Vdata, that is, the voltage of the node a is Vdata at that time, where Vdata=Vdata′+ΔV, ΔV is the difference between the second data voltage Vdata and the first data voltage Vdata′, and in particular, ΔV is a negative value.

Since the first transistor T1 and the fourth transistor T4 are both turned off, the node b is in a floating state. Compared with the previous phase, the voltage of the first end (node a) of the capacitor C changes, so the capacitor C generates a bootstrap effect to ensure that the voltage difference between its two ends is constant, so that the voltage of the second end (node b) thereof undergoes an isotonic transition. That is to say, at that time, the voltage of the second end of the capacitor C becomes Vdd+Vth+ΔV, that is, the control voltage inputted to the control terminal of the driving transistor DTFT is equal to a sum of the difference between the second data voltage provided by the data line Data in the data writing phase and the first data voltage provided in the reset phase and the reset voltage.

In the lighting phase t3, the first control signal terminal Scan1 provides a low level signal, the second control signal terminal Scan2 and the third control signal terminal Scan3 provide a high level signal, and the light emission control signal terminal EM provides a low level signal. At that time, the first transistor T1 and the fourth transistor T4 are both turned on, and the second transistor T2 and the third transistor T3 are both turned off.

FIG. 8 is an equivalent circuit diagram of the pixel circuit shown in FIG. 4 in the light emitting phase. As shown in FIG. 8, since the first transistor T1 is turned on, the first voltage Vdd provided by the first power supply terminal is VDD is written to the first terminal of the driving transistor DTFT through the first transistor T1, and at that time, the driving transistor DTFT is turned on again. According to the saturated driving current formula of the driving transistor DTFT, it can be obtained:

$$\begin{matrix}I = {{K}^{*} ( Vgs - Vth )}^{2} \\ = {{K}^{*} ( Vdd + Vth + Δ V - Vdd - Vth )}^{2} \\ = {{K}^{*} ( Δ V )}^{2}\end{matrix}$$

where K is a constant and Vgs is a gate-source voltage of the driving transistor DTFT. It can be seen from the above formula that the driving current of the driving transistor DTFT is related to the transition voltage (that is, the difference between the second data voltage and the first data voltage) provided by the data line Data in the data writing phase, and is independent of the threshold voltage of the driving transistor DTFT. Thus, threshold voltage compensation for the driving transistor DTFT can be achieved.

Further, by controlling the transition voltage provided by the data line Data in the data writing phase, the driving current outputted by the driving transistor DTFT can be controlled.

It is to be noted that each transistor in the pixel circuit being a P-type thin film transistor is only an exemplary embodiment of the present disclosure, which does not limit the technical solution of the present disclosure. It will be appreciated by those skilled in the art that by changing the types of at least part of the transistors in the pixel circuit (e.g. changing from a P-type transistor to an N-type transistor), and correspondingly changing the control signal provided by the control signal terminal (for example, changing from a low level to a high level), other embodiments can be obtained without departing from the spirit and scope of the present disclosure.

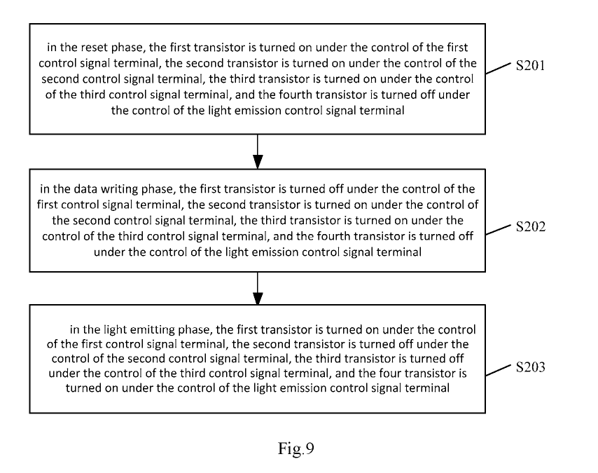

FIG. 9 is a flow chart of another pixel driving method according to an embodiment of the present disclosure. This pixel driving method is based on the above-described pixel circuit shown in FIG. 4. As shown in FIG. 9, at step S201, in the reset phase, the first transistor is turned on under the control of the first control signal terminal, the second transistor is turned on under the control of the second control signal terminal, the third transistor is turned on under the control of the third control signal terminal, and the fourth transistor is turned off under the control of the light emission control signal terminal.

In step S201, initially, the first transistor T1, the second transistor T2, the third transistor T3, and the driving transistor DTFT are all turned on. The first power supply terminal charges the control terminal of the driving transistor DTFT through the first transistor T1, the driving transistor DTFT and the third transistor T3 sequentially until the voltage of the control terminal of the driving transistor DTFT reaches the reset voltage and is thus turned off. The value of the reset voltage is equal to a sum of the first voltage provided by the first power supply terminal and the threshold voltage of the driving transistor DTFT.

At the same time, the first data voltage provided by the data line Data is written to the first end of the capacitor C through the second transistor T2.

At step S202, in the data writing phase, the first transistor is turned off under the control of the first control signal terminal, the second transistor is turned on under the control of the second control signal terminal, the third transistor is turned on under the control of the third control signal terminal, and the fourth transistor is turned off under the control of the light emission control signal terminal.

In step S202, the first transistor T1 and the fourth transistor T4 are both turned off, and the second end of the capacitor C is in a floating state. The second transistor T2 is turned on, so the second data voltage provided by the data line Data is written to the first end of the capacitor C through the second transistor T2. The second end of the capacitor C transitions to the control voltage by means of a bootstrap effect, and the control voltage is equal to a sum of the difference between the second data voltage provided by the data line Data in the data writing phase and the first data voltage provided by the data line Data in the reset phase and the reset voltage.

It is to be noted that, in the data writing phase, since the first transistor T1 and the fourth transistor T4 are both in an off state, no matter whether the third transistor T3 is in an on state or an off state, it does not affect the second end of the capacitor C being in a floating state. Therefore, as an optional scheme in this embodiment, the third transistor T3 may also be turned off under the control of the third control signal terminal Scan3 in the data writing phase, which will not be described in detail here.

At step S203, in the light emitting phase, the first transistor is turned on under the control of the first control signal terminal, the second transistor is turned off under the control of the second control signal terminal, the third transistor is turned off under the control of the third control signal terminal, and the four transistor is turned on under the control of the light emission control signal terminal.

In step S203, the first transistor T1 is turned on, thus the first voltage provided by the first power supply terminal is written to the first terminal of the driving transistor DTFT. At that time, the driving transistor DTFT is turned on and outputs a driving current. The driving current is determined by the control voltage of the control terminal of the driving transistor DTFT.

According to the saturated driving current formula of the driving transistor DTFT, it can be obtained:

$$\begin{matrix}I = {{K}^{*} ( Vgs - Vth )}^{2} \\ = {{K}^{*} ( Vdd + Vth + Δ V - Vdd - Vth )}^{2} \\ = {{K}^{*} ( Δ V )}^{2}\end{matrix}$$

where K is a constant and Vgs is the gate-source voltage of the driving transistor DTFT. It can be seen from the above formula that the driving current of the driving transistor DTFT is related to the transition voltage (i.e. the difference between the second data voltage and the first data voltage) provided by the data line Data in the data writing phase, and is independent of the threshold voltage of the driving transistor DTFT. Thus, threshold voltage compensation for the driving transistor DTFT can be achieved.

Further, by controlling the transition voltage provided by the data line Data in the data writing phase, the driving current outputted by the driving transistor DTFT can be controlled.

In the pixel circuit and pixel driving method described above, a reset voltage equal to a sum of the first voltage and the threshold voltage of the driving transistor is written to the control terminal of the driving transistor by the threshold compensation sub-circuit in the reset phase, and a control voltage related to the reset voltage and the data voltage provided by the data line is written to the control terminal of the driving transistor by the threshold compensation sub-circuit in the data writing phase, so that the driving current generated by the driving transistor in the light emitting phase is independent of the threshold voltage of the driving transistor, which thus eliminates the influence of the drift of the threshold voltage of the driving transistor on the driving current of the light emitting device, thereby effectively improving the luminance uniformity of pixels in the display device.

An embodiment of the present disclosure further provides a display device comprising any of the pixel circuits described above.

It can be understood that the above embodiments are exemplary embodiments used only for illustrating the principle of the present disclosure, and that the present disclosure is not so limited. Various variations and improvements may be made by those ordinarily skilled in the art without departing from the spirit and essence of the present disclosure. These variations and improvements are regarded as falling within the scope of the present disclosure.

1. A pixel circuit comprising:
a driving transistor;
a threshold compensation sub-circuit; and
a light emission control sub-circuit,
wherein a control terminal, a first terminal and a second terminal of the driving transistor are connected to the threshold compensation sub-circuit,
wherein the threshold compensation sub-circuit is connected to a data line, a first power supply terminal, a first control signal terminal, a second control signal terminal, a third control signal terminal, and the light emission control sub-circuit,
wherein the light emission control sub-circuit is connected to a first end of a light emitting device and a light emission control signal terminal,
wherein a second end of the light emitting device is connected to a second power supply terminal,
wherein the threshold compensation sub-circuit is configured to write a reset voltage to the control terminal of the driving transistor in a reset phase under control of the first control signal terminal, the second control signal terminal and the third control signal terminal,
wherein the reset voltage is equal to a sum of a first voltage provided by the first power supply terminal and a threshold voltage of the driving transistor,
wherein the threshold compensation sub-circuit is configured to write a control voltage to the control terminal of the driving transistor in a data writing phase,
wherein the control voltage is related to the reset voltage and a data voltage provided by the data line,
wherein the driving transistor is configured to generate a driving current according to the control voltage in a light emitting phase, and
wherein the light emission control sub-circuit is configured to output the driving current to the light emitting device in the light emission phase under the control of the light emission control signal terminal to drive the light emitting device to emit light.

2. The pixel circuit according to claim 1, wherein the control voltage is equal to a sum of a difference between a second data voltage provided by the data line in the data writing phase and a first data voltage provided by the data line in the reset phase and the reset voltage.

3. The pixel circuit according to claim 1, wherein the threshold compensation sub-circuit comprises a first transistor, a second transistor, a third transistor, and a capacitor,
wherein a control terminal of the first transistor is connected to the first control signal terminal, a first terminal of the first transistor is connected to the first power supply terminal, and a second terminal of the first transistor is connected to the first terminal of the driving transistor,
wherein a control terminal of the second transistor is connected to the second control signal terminal, a first terminal of the second transistor is connected to the data line, and a second terminal of the second transistor is connected to a first end of the capacitor, and
wherein a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor.

4. The pixel circuit according to claim 1, wherein the second control signal terminal and the third control signal terminal are a same control signal terminal.

5. The pixel circuit according to claim 1,
wherein the light emission control sub-circuit comprises a fourth transistor, and
wherein a control terminal of the fourth transistor is connected to a light emission control signal line, a first terminal of the fourth transistor is connected to the second terminal of the driving transistor, and a second terminal of the fourth transistor is connected to the first end of the light emitting device.

6. The pixel circuit according to claim 1,
wherein the threshold compensation sub-circuit comprises a first transistor, a second transistor, a third transistor, and a capacitor, and the light emission control sub-circuit comprises a fourth transistor,
wherein a control terminal of the first transistor is connected to the first control signal terminal, a first terminal of the first transistor is connected to the first power supply terminal, and a second terminal of the first transistor is connected to the first terminal of the driving transistor,
wherein a control terminal of the second transistor is connected to the second control signal terminal, a first terminal of the second transistor is connected to the data line, and a second terminal of the second transistor is connected to a first end of the capacitor,
wherein a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor, and
wherein a control terminal of the fourth transistor is connected to a light emission control signal line, a first terminal of the fourth transistor is connected to the second terminal of the driving transistor, and a second terminal of the fourth transistor is connected to a first end of the light emitting device.

7. The pixel circuit according to claim 6, wherein the first transistor, the second transistor, the third transistor, the fourth transistor, and the driving transistor are P-type transistors.

8. A display device comprising the pixel circuit according to claim 1.

9. A pixel driving method, using the pixel circuit according to claim 1, wherein the pixel driving method comprises:
in a reset phase, writing, by the threshold compensation sub-circuit, a reset voltage to the control terminal of the driving transistor, wherein the reset voltage is equal to a sum of a first voltage provided by the first power supply terminal and a threshold voltage of the driving transistor;
in a data writing phase, writing, by the threshold compensation sub-circuit, a control voltage to the control terminal of the driving transistor, wherein the control voltage is related to the reset voltage and a data voltage provided by the data line; and
in the light emitting phase, generating, by the driving transistor, a driving current according to the control voltage, and outputting, by the light emission control sub-circuit, the driving current to the light emitting device to drive the light emitting device to emit light.

10. The pixel driving method according to claim 9,
wherein the threshold compensation sub-circuit comprises a first transistor, a second transistor, a third transistor, and a capacitor, and the light emission control sub-circuit comprises a fourth transistor,
wherein a control terminal of the first transistor is connected to the first control signal terminal, a first terminal of the first transistor is connected to the first power supply terminal, and a second terminal of the first transistor is connected to the first terminal of the driving transistor,
wherein a control terminal of the second transistor is connected to the second control signal terminal, a first terminal of the second transistor is connected to the data line, and a second terminal of the second transistor is connected to a first end of the capacitor,
wherein a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor,
wherein a control terminal of the fourth transistor is connected to a light emission control signal line, a first terminal of the fourth transistor is connected to the second terminal of the driving transistor, and a second terminal of the fourth transistor is connected to a first end of the light emitting device,
wherein in the reset phase, the writing, by the threshold compensation sub-circuit, a reset voltage to the control terminal of the driving transistor comprises:
turning on the first transistor under the control of the first control signal terminal,
turning on the second transistor under the control of the second control signal terminal;
turning on the third transistor under the control of the third control signal terminal; and
turning off the fourth transistor under the control of the light emission control signal terminal.

11. The pixel driving method according to claim 1,
wherein the threshold compensation sub-circuit comprises a first transistor, a second transistor, a third transistor, and a capacitor, and the light emission control sub-circuit comprises a fourth transistor,
wherein a control terminal of the first transistor is connected to the first control signal terminal, a first terminal of the first transistor is connected to the first power supply terminal, and a second terminal of the first transistor is connected to the first terminal of the driving transistor,
wherein a control terminal of the second transistor is connected to the second control signal terminal, a first terminal of the second transistor is connected to the data line, and a second terminal of the second transistor is connected to a first end of the capacitor,
wherein a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor,
wherein a control terminal of the fourth transistor is connected to a light emission control signal line, a first terminal of the fourth transistor is connected to the second terminal of the driving transistor, and a second terminal of the fourth transistor is connected to a first end of the light emitting device,
wherein in the data writing phase, the writing, by the threshold compensation sub-circuit, a control voltage to the control terminal of the driving transistor comprises:
turning off the first transistor under the control of the first control signal terminal;
turning on the second transistor under the control of the second control signal terminal;
turning on the third transistor under the control of the third control signal terminal; and
turning off the fourth transistor under the control of the light emission control signal terminal.

12. The pixel driving method according to claim 1,
wherein the threshold compensation sub-circuit comprises a first transistor, a second transistor, a third transistor, and a capacitor, and the light emission control sub-circuit comprises a fourth transistor,
wherein a control terminal of the first transistor is connected to the first control signal terminal, a first terminal of the first transistor is connected to the first power supply terminal, and a second terminal of the first transistor is connected to the first terminal of the driving transistor,
wherein a control terminal of the second transistor is connected to the second control signal terminal, a first terminal of the second transistor is connected to the data line, and a second terminal of the second transistor is connected to a first end of the capacitor,
wherein a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor,
wherein a control terminal of the fourth transistor is connected to a light emission control signal line, a first terminal of the fourth transistor is connected to the second terminal of the driving transistor, and a second terminal of the fourth transistor is connected to a first end of the light emitting device,
in the light emitting phase, generating, by the driving transistor, the driving current according to the control voltage, and outputting, by the light emission control sub-circuit, the driving current to the light emitting device to drive the light emitting device to emit light comprises:
turning on the first transistor under the control of the first control signal terminal;
turning off the second transistor under the control of the second control signal terminal;
turning off the third transistor under the control of the third control signal terminal; and
turning on the fourth transistor under the control of the light emission control signal terminal.

13. The display device according to claim 8, wherein the control voltage is equal to a sum of a difference between a second data voltage provided by the data line in the data writing phase and a first data voltage provided by the data line in the reset phase and the reset voltage.

14. The display device according to claim 8,
wherein the threshold compensation sub-circuit comprises a first transistor, a second transistor, a third transistor, and a capacitor;
wherein a control terminal of the first transistor is connected to the first control signal terminal, a first terminal of the first transistor is connected to the first power supply terminal, and a second terminal of the first transistor is connected to the first terminal of the driving transistor,
wherein a control terminal of the second transistor is connected to the second control signal terminal, a first terminal of the second transistor is connected to the data line, and a second terminal of the second transistor is connected to a first end of the capacitor, and
wherein a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor.

15. The display device according to claim 8, wherein the second control signal terminal and the third control signal terminal are a same control signal terminal.

16. The display device according to claim 8,
wherein the light emission control sub-circuit comprises a fourth transistor, and
wherein a control terminal of the fourth transistor is connected to a light emission control signal line, a first terminal of the fourth transistor is connected to the second terminal of the driving transistor, and a second terminal of the fourth transistor is connected to the first end of the light emitting device.

17. The display device according to claim 8,
wherein the threshold compensation sub-circuit comprises a first transistor, a second transistor, a third transistor, and a capacitor, and the light emission control sub-circuit comprises a fourth transistor,
wherein a control terminal of the first transistor is connected to the first control signal terminal, a first terminal of the first transistor is connected to the first power supply terminal, and a second terminal of the first transistor is connected to the first terminal of the driving transistor,
wherein a control terminal of the second transistor is connected to the second control signal terminal, a first terminal of the second transistor is connected to the data line, and a second terminal of the second transistor is connected to a first end of the capacitor,
wherein a control terminal of the third transistor is connected to the third control signal terminal, a first terminal of the third transistor is connected to the second terminal of the driving transistor, and a second terminal of the third transistor is connected to a second end of the capacitor and the control terminal of the driving transistor, and
wherein a control terminal of the fourth transistor is connected to a light emission control signal line, a first terminal of the fourth transistor is connected to the second terminal of the driving transistor, and a second terminal of the fourth transistor is connected to a first end of the light emitting device.

18. The display device according to claim 17, wherein the first transistor, the second transistor, the third transistor, the fourth transistor, and the driving transistor are P-type transistors.

19. The pixel driving method according to claim 9, wherein the control voltage is equal to a sum of a difference between a second data voltage provided by the data line in the data writing phase and a first data voltage provided by the data line in the reset phase and the reset voltage.

20. The pixel driving method according to claim 9, wherein the second control signal terminal and the third control signal terminal are a same control signal terminal.
